(19) United States
(12) Patent Application Publication
(10) Pub. No.: US 2002/0154099 A1
(43) Pub. Date: Oct. 24, 2002

(54) Protector for data transmitting/receiving terminal

(76) Inventor: Young-Jin Oh, Namyangju-si (KR)

Correspondence Address: LAW OFFICES OF BRIAN S STEINBERGER, 101 BREVARD AVENUE, COCOA, FL, 32922, US

(21) Appl. No.: 09/993,987

(22) Filed: Nov. 16, 2001

(30) Foreign Application Priority Data
Apr. 24, 2001 (KR) 2001-21940

(51) Int. Cl. G09G 5/00

(52) U.S. Cl. 345/173

(57) ABSTRACT

A protector for a wired/wireless data transmitting/receiving terminal and a wired/wireless data transmitting/receiving terminal having the same. The protector prevents a display or a touch screen from getting damaged while maintaining characteristics and commercial value of the terminal employing a digitizer (touch screen) as a display or input device. A data transmitting/receiving terminal comprises a sheet protector installed on a display or a touch screen of a terminal bodyand includes a support band capable of attaching the sheet protector as a complementary structure to one end at regions at least excluding a display area. The protector includes a support band supported or attached to the support band of the terminal body and extends from the support band so as to cover the display and the touch screen. The invention can be applied to a protector for a display.

This invention claims the benefit of priority to Korean Patent Application No. 2001-21940 filed Apr. 24, 2001. The present invention relates to a protector for a wired or wireless data transmitting/receiving terminal and to a wired or wireless data transmitting/receiving terminal having the same, and more particularly, to a sheet protector for preventing a display or a touch screen from getting damaged while maintaining the characteristics and commercial value of a terminal employing a digitizer (touch screen) as a display or input device.

### BACKGROUND AND PRIOR ART

A general wired or wireless data transmitting/receiving terminal selectively comprises a system terminal body having a program memory and a drive control board included therein, an input device for driving a system, and a cover for protecting a display along with or separately from the input device.

In a desktop computer separately comprising a CPU, a display (monitor) and an input device (keyboard), there is no cover for protecting the display. However, in a notebook computer, a hardboard cover for covering and protecting the display is engaged with a CPU body so as to be fold and unfolded.

Terminals capable of performing wired or wireless data transmitting/receiving functions are greatly divided into a desktop computer, a notebook computer, a personal digital assistant (PDA) and the like. Among these devices, considering their carrying possibility or necessity, a terminal capable of performing wireless data transmitting/receiving functions is only a notebook computer or a personal digital assistant similar thereto.

“Web Pad” known as a brand name of a functional terminal capable of performing wireless access to the internet even while being carried with a user is a representative type of personal digital assistants of these wireless data terminals. Since this terminal is used with one hand used for holding a terminal body and the other hand used for inputting, input devices such as a mouse, a keyboard or the like can be hardly used.

FIGS. 1(a) and 1(b) show a terminal comprising a terminal body 10 and a display 11 integrally formed therein. Input buttons 12 substituting for a portion of input function of a mouse, a keyboard or the like are appropriately arranged at edges on the plane of the terminal body 10 excluding the area of the display 11, and the flat panel display 11 is mounted on the terminal body 10. A reference numeral 13 designates a speaker.

FIGS. 2(a) and 2(b) show another terminal comprising a terminal body 10 and a display 11 integrally formed therein. In the same way as the structure as shown in FIG. 1, this structure includes input buttons 12 substituting for a portion of input function of a mouse, a keyboard or the like appropriately arranged at the edges on the plane of the terminal body 10 excluding the area of the display 11. The flat panel display 11 is mounted on the terminal body 10, and a touch screen 14 is added onto the flat panel display 11. In this structure, the input buttons 12 are not mounted on the terminal body 10, and all inputs by the user can be received from the touch screen 14.

Although the terminals shown in FIGS. 1 and 2 have a structural difference between their input methods in connection with accommodation of the touch screen, they have common characteristics in that optimal usage environment can be provided by a terminal capable of performing mobile wireless data transmitting/receiving functions. In virtue of these characteristics, they can perform the data transmitting/receiving functions regardless of the place. Meanwhile, when the touch screen 14 as shown in FIG. 2 is used, compared to other input devices such as a mouse or a keyboard, it is easy to input, few operational errors are generated, and characters can be inputted with a hand. Therefore, they can provide a high degree of graphical user interface environment.

Although the terminals are available in a variety of applications and easy to use, when they are not in use, stored, or carried to other places, the display 11 or the touch screen 14 is exposed to the outside. Thus, there is a disadvantage in that they are apt to get damaged by the scratching from the outer environment. Especially, the touch screen 14 has been reinforced in view of the manufacturing technique related to its design and processing including high reliability, new functions, durability, material or substance rather than a general function as an input device in the initial stage.

As for the detecting method, there is a resistive touch panel that is constructed by bonding together two sheets having different resistance components arranged such that the two sheets can be isolated by spacers and contacted with each other by a pressing action. Further, there are a capacitive touch panel, an ultrasonic wave touch panel, an optical (infrared) sensor touch panel, an electromagnetic induction touch panel, etc. Since they have properties different from each other according to their signal amplification problems or resolution differences and their degrees of difficulty of designs and fabricating techniques, the detecting methods should be determined in consideration of durability, economical efficiency and the like thereof in addition to optical property, electrical property, mechanical property, environmental resistance, input property and the like. The resistive touch panel is largely applied to the wireless data terminal.

The resistive touch screen comprises an upper substrate and an underlying lower substrate, which are bonded with transparent conductive films thereof facing each other. The upper substrate comes into contact with the lower substrate by pressure applied at a time of inputting. Since the upper substrate is made of a flexible PET film or a thin glass sheet, there is a weak point in that it is apt to get damaged even by a small impact and the uniformity of film quality or the linearity of detection is apt to be deteriorated. The detection of an input position is made by a structure configured such that the upper and lower substrates with electrodes put thereinto face each other by means of dot spacers, and that input signals are extracted by a connector tail. As for its operation, the upper substrate comes into contact with the lower substrate on an input point and a voltage is applied between the electrodes of the lower substrate so that a potential gradient is produced on resistive surfaces between both electrodes. The resulting voltage is read through the electrodes of the upper substrate and an X-axis input position is then calculated. Subsequently, a voltage is applied between the electrodes of the upper substrate and the resulting voltage is read through the electrodes of the lower substrate so as to calculate a Y-axis input position. Thus, the input point is shown on the display. By repeating the above procedures at a high rate, input positions are continuously shown on the display so that characters or lines are drawn.

The touch screen 14 as an input device has been developed according to the multi-purpose trend of the touch screen loaded products. Especially, as an LCD as the display 11 has been largely used, demands on the touch screen loaded on the LCD have increased. When the uniformity of the transparent conductive film, the linearity of the electrodes or the like is deformed or damaged due to an external impact, there is a weak point in that an input position at the deformed or broken point cannot be detected or showed on the display, and in that this has a negative impact on the reliability.

A lamination structure in which the touch screen 14 is added to the flat panel display 11 as shown in FIG. 2 is schematically illustrated in the section view of FIG. 3. A polarizer 17 is mounted below the touch screen 14 comprising an upper substrate 15 and a lower substrate 16. A liquid crystal display 18 is mounted below the polarizer 17. Another polarizer 17 is mounted below the liquid crystal display 18. Then, they are incorporated and laminated together. The lamination constitution varies according to design conditions such as the maintenance of an optical axis, light transmissivity, thinness, miniaturization and lightness.

The terminal with the display 11 exposed as shown in FIG. 1, the terminal with the touch screen 14 exposed as shown in FIG. 2, or wired or wireless data transmitting/receiving terminals with a similar display exposed are apt to get damaged due to the influence from the outer environment. When the touch screen as an input device is added, it is apt to get damaged even by scratching during moving or using.

A method capable of protecting the display 11 or the touch screen 14 by mounting a cover on the terminal body 10 includes a method of mounting the cover 22 on an end side of the terminal body 10 as shown in FIG. 4. It seems that the structure as shown in FIG. 4 is a structure capable of solving the protection problem of the display 11 or the touch screen 14 by applying the structure of the notebook computer to the wired or wireless data transmitting/receiving terminal of FIGS. 1 and 2. However, this accompanies functional or structural problems, which can be seen referring to the notebook computer and its cover structure in FIG. 5.

FIG. 5 shows a notebook computer 21 having the display 11 integrated with a cover 20 instead of mounting it on a system body 19. By manufacturing the cover 20 as a hard cover made of plastic or alloy material and mounting the display 11 on its inner side surface, this structure can avoid damage applied on the display 11 at least when not in use. When the cover 20 is mounted on the system body 19 so as to be folded and unfolded to the system body 19, the display is safe during moving or keeping. However, when in use, there are disadvantages in that the unfolded cover 20 occupies a physically wide space, and in that when the computer is used with one hand, since the input device and the display are deployed into two parts, there is a probability of hindering a user's view. In addition, there is a problem in that the cover becomes a limit factor in the design of lightness and thinness.

Therefore, the prior wired or wireless data transmitting/receiving terminals have an advantage in that it can provide the user with the convenience of mobility, applicability and usability. However, there is a problem in that since the display is structurally exposed to the outside, it is apt to be broken or get damaged due to an impact and image quality is lowered or a display function is lost. When the structure with the touch screen added thereto is applied as an input device, there is a problem in that since the film quality of the touch screen get damaged and the linearity degree of the electrodes is deteriorated, an input function and accordingly a display function cannot be well performed. In addition, when only the cover is installed for the purpose of protecting the display or touch screen, considering its original usage purpose, there is a problem in that it is not appropriate to the user's environment.

### SUMMARY OF THE INVENTION

An object of the present invention is to provide to a protector for a display suitable for usage purpose of a wired or wireless data transmitting/receiving terminal and to a wired or wireless data transmitting/receiving terminal having the same.

Another object of the present invention is to provide a protector for protecting a touch screen added to a wired or wireless data transmitting/receiving terminal.

A further object of the present invention is to make a protector thin and add it to a wired or wireless data transmitting/receiving terminal.

According to an aspect of the present invention for achieving the above objects, there is provided a data transmitting/receiving terminal with a terminal body and a display integrally formed therein. The terminal body has the display mounted thereon and input buttons arranged at regions excluding a display area and substituting for a portion of input function of a mouse, a keyboard or the like. A sheet protector is installed on the display of the terminal body. The terminal body includes a support band capable of supporting or arbitrarily attaching the sheet protector as a complementary structure to its one end at regions at least excluding the display area. The sheet protector includes a support band supported by or arbitrarily attached to the support band of the terminal body and extends from the support band so as to cover the display area and hide the surface of the terminal body.

According to another aspect of the present invention, there is also provided a data transmitting/receiving terminal comprising a data transmitting/receiving terminal body, a display lying on a portion of the terminal body, and a touch screen added onto the display, which are integrally formed sequentially from below. A sheet protector is installed on the top surface of the touch screen lying on the top surface of the display integrally formed with the terminal body. The terminal body includes a support band capable of supporting or arbitrarily attaching the sheet protector as a complementary structure to its one end at regions at least excluding an active area of the display and touch screen. The sheet protector includes a support band supported by or arbitrarily attached to the support band of the terminal body so as to hide the active area of the display and touch screen of the terminal body.

When the flexible sheet protector is installed on the top surface of the display and touch screen of the data transmitting/receiving terminal body, the entire lamination structure of the terminal body, the display and the touch screen can be adapted to design conditions such as thinness and lightness, and can effectively prevent the display and touch screen from being scratched or damaged.

Further objects and advantages of this invention will be apparent from the following detailed description of a presently preferred embodiment which is illustrated schematically in the accompanying drawings.

### BRIEF DESCRIPTION OF THE DRAWINGS

FIGS. 1(a) and 1(b) are views illustrating a conventional data transmitting/receiving terminal, wherein FIG. 1(a) is a perspective view and FIG. 1(b) is a sectional view.

FIGS. 2(a) and 2(b) are views illustrating another conventional data transmitting/receiving terminal, wherein FIG. 2(a) is a partially cut-away perspective view and FIG. 2(b) is a sectional view.

FIG. 3 is a view explaining a lamination structure of a typical digitizer.

FIG. 4 is a perspective view of a data transmitting/receiving terminal having a cover.

FIG. 5 is a view illustrating the structure of a typical notebook computer.

FIG. 6 is a partially cut-away perspective view of a data transmitting/receiving terminal according to the present invention.

FIGS. 7(a) and 7(b) are schematic views illustrating the structure of the data transmitting/receiving terminal according to the present invention, wherein FIG. 7(a) is a perspective view and FIG. 7(b) is a sectional view.

FIGS. 8(a) and 8(b) are schematic views illustrating the structure of another data transmitting/receiving terminal according to the present invention, wherein FIG. 8(a) is a perspective view and FIG. 8(b) is a sectional view.

FIG. 9 is a view illustrating the connecting structure of a protector for the data transmitting/receiving terminal related to the application of the present invention.

FIGS. 10(a), 10(b) and 10(c) are views illustrating the connecting structures of the protector according to the present invention, wherein FIG. 10(a) is a button type, FIG. 10(b) is a tape type and FIG. 10(c) is a magnetic type.

FIG. 11 is a schematic view of an embodiment of the connection of the protector according to the present invention.

FIG. 12 is a schematic view of another embodiment of the connection of the sheet protector according to the present invention.

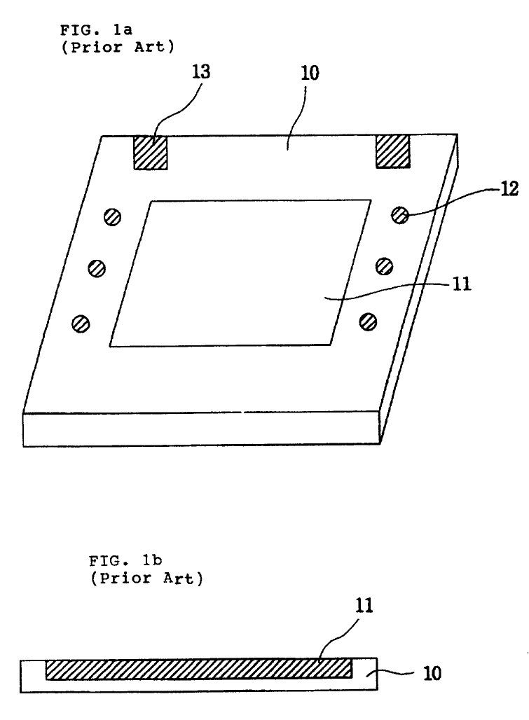

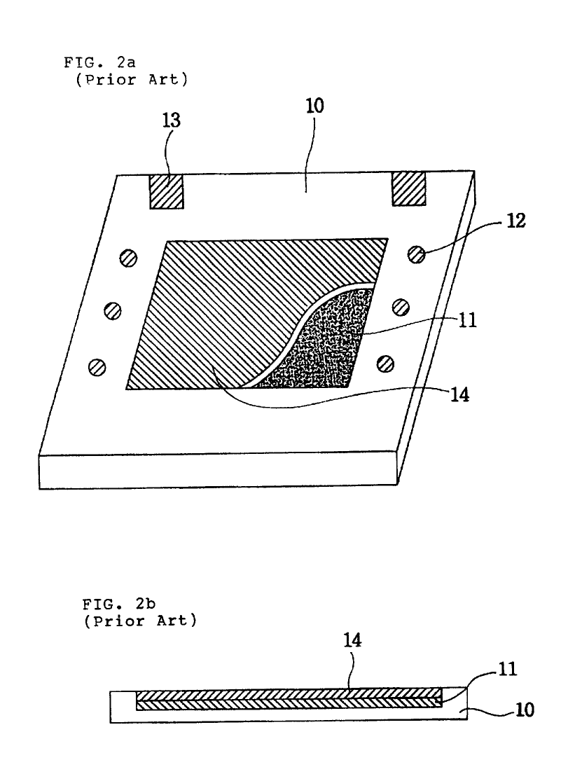

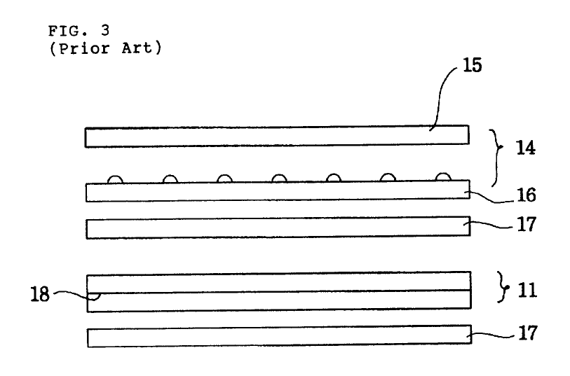

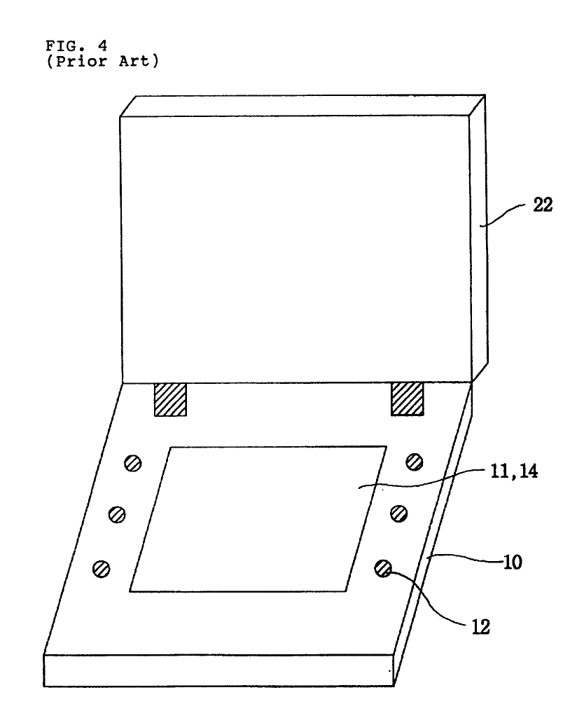

### DETAILED DESCRIPTION OF THE INVENTION

Before explaining the disclosed embodiments of the present invention in detail it is to be understood that the invention is not limited in its application to the details of the particular arrangement shown since the invention is capable of other embodiments. Also, the terminology used herein is for the purpose of description and not of limitation.

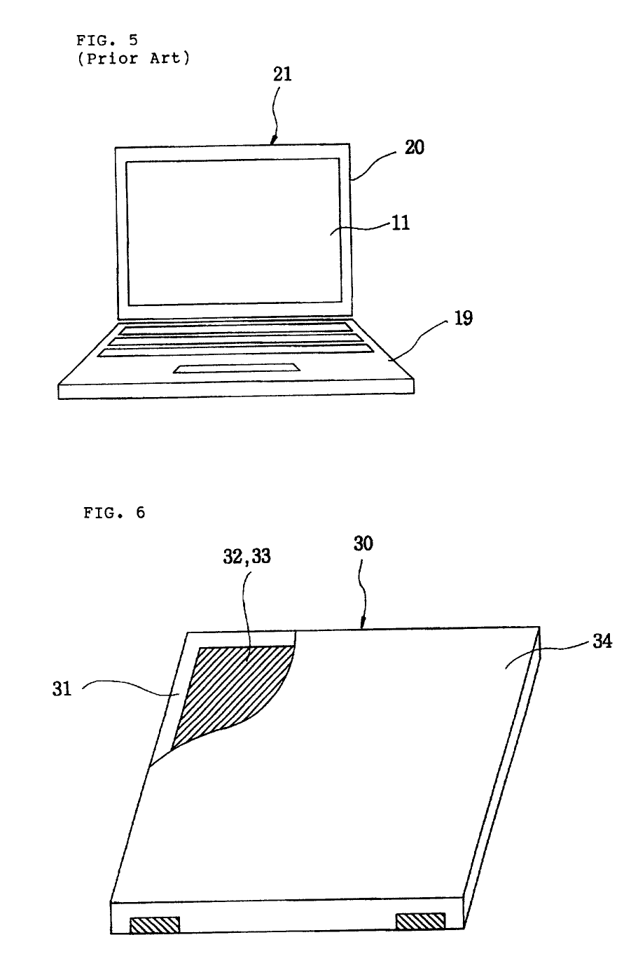

FIG. 6 is a partially cut-away perspective view of a data transmitting/receiving terminal 30 according to the present invention. This structure shows an embodiment of a sheet protector 34 installed in both a terminal having a terminal body 31 and a display 32 integrally formed therein and a terminal having the terminal body 31, the display 32 and the touch screen 33 which are integrally formed.

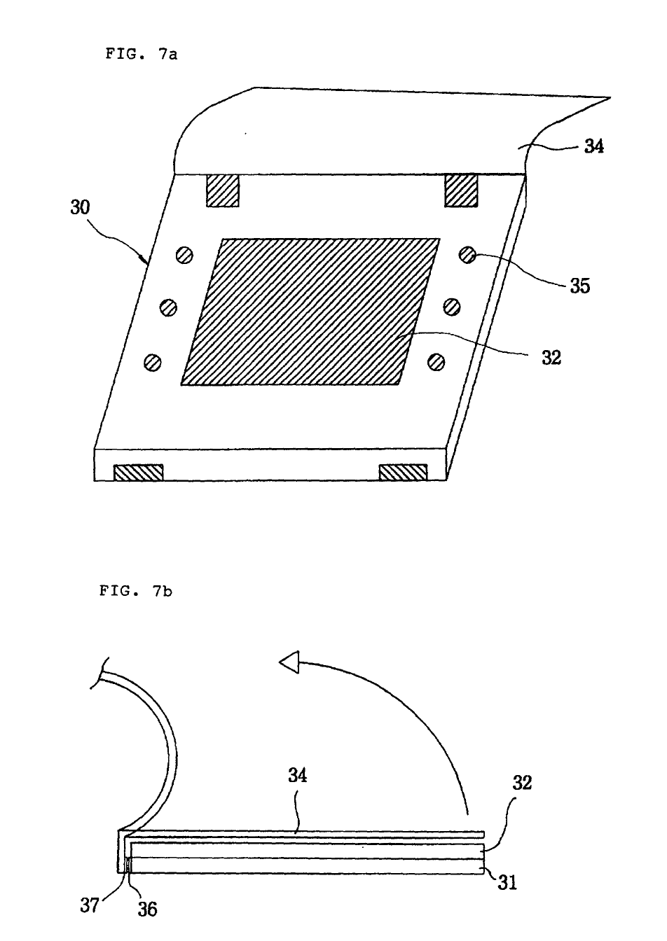

The structure of FIG. 7 includes a data transmitting/receiving terminal 30 comprising the terminal body 31 and the display 32 integrally formed therein, wherein input buttons for substituting a portion of input function of a mouse, a keyboard or the like are arranged in the terminal body 31 excluding a display area (function buttons may not exist depending on input devices, i.e., their characteristics), and wherein the display 32 is mounted on the terminal body 31. The structure of FIG. 7 may includes the data transmitting/receiving terminal 30 comprising the terminal body 31, the display 32 and a touch screen 33 which are integrally formed sequentially from below, wherein input buttons 35 for substituting a portion of input function of a mouse, a keyboard or the like are selectively arranged on the plane of the terminal body 31 excluding the area of the display 32, wherein the display 32 is mounted on the terminal body 31, and wherein the touch screen 33 is added onto the display 32.

According to the present invention, the data transmitting/receiving terminal 30 with the terminal body 31 and the display 32 integrally formed therein is constructed such that the sheet protector 34 is installed on the display 32 of the terminal body 31, as shown in FIGS. 7(a) and 7(b).

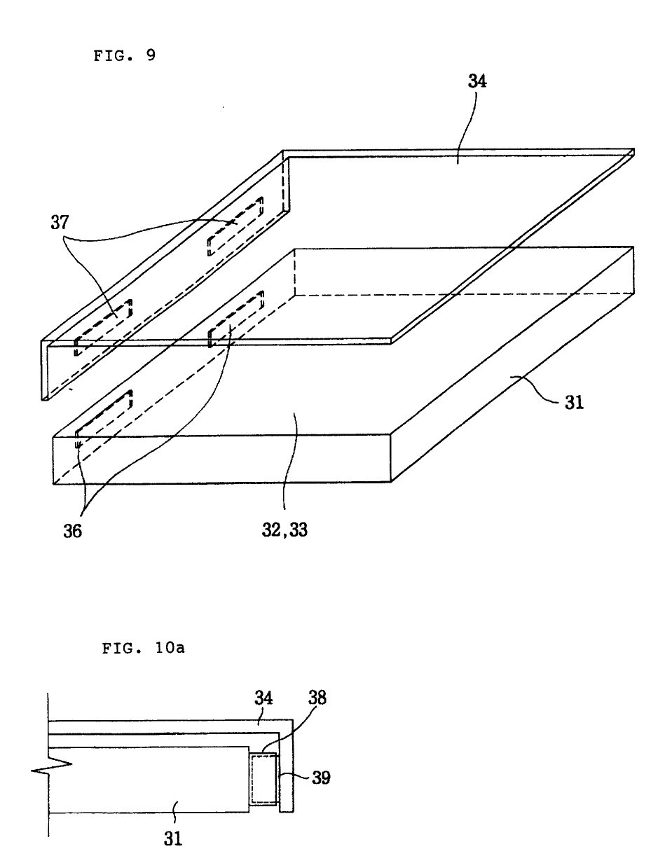

The terminal body 31 includes a support band 36 capable of supporting or attaching the sheet protector 34 as a complementary structure to its one end at regions at least excluding the area of the display 32, as shown in FIG. 9. The sheet protector 34 itself supported by or attached to the support band 36 includes a support band 37 corresponding to the support band 36 of the terminal body 31, and is incorporated with and supported by the terminal body 31. When the sheet protector is unfolded, it covers the area of the display 32 of the terminal body 31 and hides the surface of the terminal body 31.

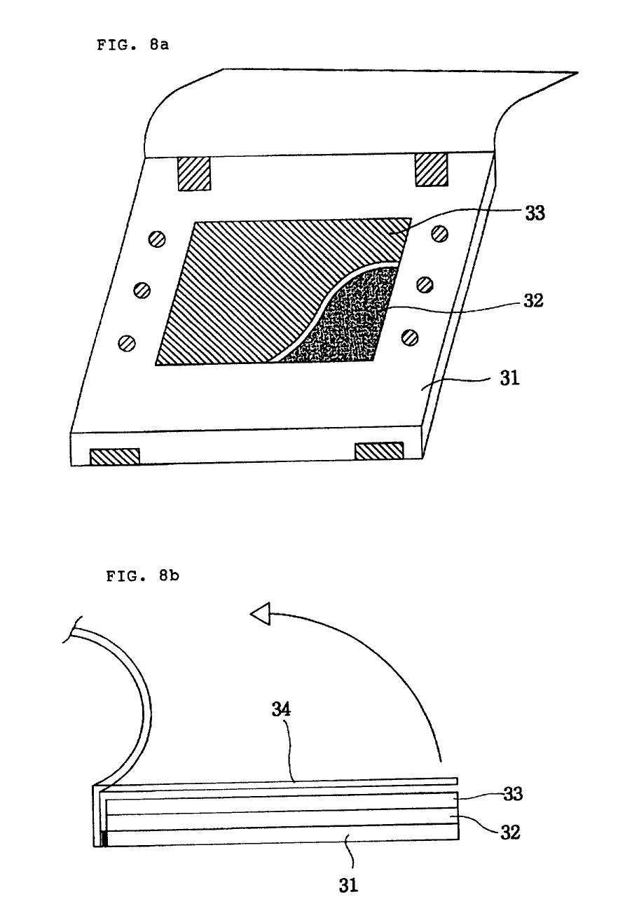

According to another aspect of the present invention, the data transmitting/receiving terminal 30 comprises the terminal body 31, the display 32 and a touch screen 33 which are integrally formed, as shown in FIGS. 8(a) and 8(b). This structure is constructed such that the sheet protector 34 is installed on the top surface of the touch screen 33 lying on the top surface of the display 32 integrally formed with the terminal body 31. In this structure, the terminal body 31 includes the support band 36 capable of supporting or attaching the sheet protector 34 as a complementary structure to its one end at regions at least excluding an active area of the display 32 and touch screen 33, as shown in FIG. 9. The sheet protector 34 itself supported by or attached to the support band 36 includes a support band 37 corresponding to the support band 36 of the terminal body 31, and is incorporated with and supported by the terminal body 31. When the sheet protector is unfolded, it covers the active area of the display 32 and the touch screen 33 of the terminal body 31 and hides the surface of the terminal body 31.

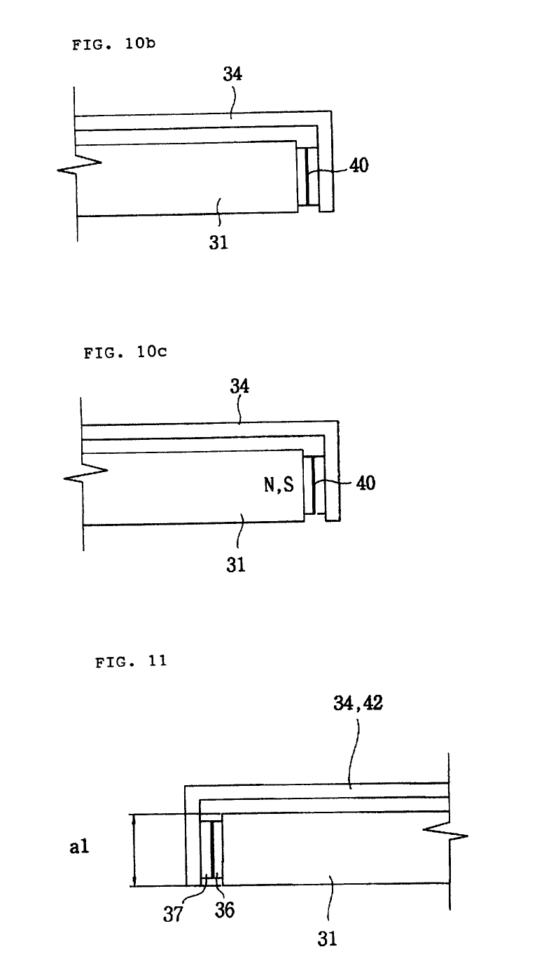

The representative structure applicable to the support bands 36, 37 included in the terminal body 31 and the sheet protector 34 are shown in FIGS. 10(a), 10(b) and 10(c). Male and female buttons 38, 39 are used in FIG. 10(a), a Teflon tape 40 is used in FIG. 10(b), and a magnet 41 is used in FIG. 10(c).

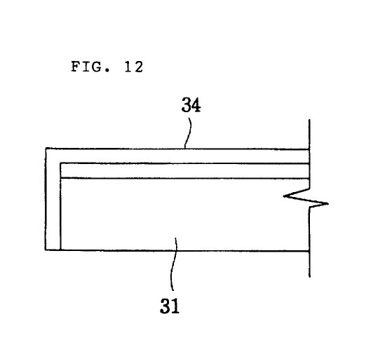

The sheet protector 34 is made of a sheet of hardboard 42 beforehand formed considering the attaching band area al of the support bands 36, 37, as shown in FIG. 11, flexible cotton fabric such as tough cloth or leather, or tough and soft LDPE (low density polyethylene) plastic. In addition, as shown in FIG. 12, the sheet protector 34 having a flexible property may be fixedly attached at one end of the terminal body 31 beforehand. In this case, it is needless to use the support bands 36, 37.

The support bands 36, 37 included in the terminal body 31 and the sheet protector 34, and the sheet protector 34 organically combined with the support bands 36, 37 can be applied as follows.

1. By setting the support band 36 of the terminal body 31 and the support band 37 of the sheet protector 34 at the attaching band area, the male and female buttons are attached to the support bands 36, 37, respectively, as shown in FIG. 10(a). In this case, the sheet protector 34 can be attached to and detached from the terminal body 31 by means of the buttons 38, 39. As for the sheet protector 34 applicable to this case, the hardboard 42 beforehand made considering the cover area of the terminal body 31 and the contact positions of the support bands 36, 37 and based on the contacted point and a folded surface can be attached to or detached from the terminal body 31. In addition, all sheets of soft synthetic or natural fabric and soft synthetic resin can be applied.

2. By setting the support band 36 of the terminal body 31 and the support band 37 of the sheet protector 34 at the attaching band area, the male and female Teflon tapes 40 are attached to the support bands 36, 37, respectively, as shown in FIG. 10(b). In this case, the material is not necessarily synthetic resin, and similar structures can be applied so far as they can repeatedly be attached and detached. As an example, the tape can be separately attached directly to the support bands 36, 37. Otherwise, the tape can be formed during the formation of the terminal body 31 or the sheet protector 34. Of course, the sheet protector 34 can be attached to and detached from terminal body 31 by means of the tape 40. As for the sheet protector 34 applicable to this case, the hardboard 42 beforehand made considering the cover area of the terminal body 31 and the contact positions of the support bands 36, 37 and based on the contacted point and folded surface can be attached to or detached from the terminal body 31. Although this structure can be applied, it is more preferable that the sheet protector of a sheet of soft synthetic or natural fabric and soft synthetic resin be applied. As shown in FIG. 10(c), a magnet 41 may be used to attach them.

The present invention can be applied particularly to at least the two types of the data transmitting/receiving terminals capable of performing wireless data transmitting/receiving functions.

For example, as shown in FIG. 6, the present invention can be applied to the data transmitting/receiving terminal 30, wherein the terminal body 31 and the display 32 are integrally formed by arranging input buttons substituting for a portion of input function of a mouse, a keyboard or the like in the terminal body 31 excluding the display area and by mounting the display 32 on the terminal body 31; a data transmitting/receiving terminal 30 comprising the terminal body 31, wherein the terminal body 31, the display 32 and the touch screen 33 are integrally formed sequentially from below by selectively arranging input buttons 35 substituting for a portion of input function of a mouse, a keyboard or the like on the plane of the terminal body 31 excluding the display area 32, mounting the display 32 on the terminal body 31, and adding the touch screen 33 onto the display 32; or all similar terminals.

When the sheet protector 34 is installed on the display 32 of the terminal body 31 with the display 32 integrally formed therein, and the support band 36 of the terminal body 31 and the support band 37 of the sheet protector 34 are fitly attached, the entire display 32 is hidden by the sheet protector 34. Thus, since the hidden width is regulated in accordance with the size of the sheet protector 34, the hidden surface area can be regulated.

When a free end of the sheet protector 34 is turned over in a state that the support band 37 of the sheet protector 34 is attached to the support band 36 of the terminal body 31, the display 32 is exposed to the outside and the terminal can be used. To the contrary, when the sheet protector 34 is returned to its original position, the display 32 is hidden.

The button type, the tape type or the magnetic type can be applied to the attaching structure of the support band 36, 37. There is no functional priority according to usage of the types. However, since the support band of the button type, the tape type or the magnetic type enables the sheet protector 34 to be attached to or detached from the terminal body 31, the sheet protector 34 can be exchanged. Sometimes, the sheet protector 34 can not be used.

When the sheet protector 34 was beforehand attached to the terminal body 31, it is convenient in that the sheet protector 34 can be folded and unfolded immediately without attaching and detaching the support bands. However, since the sheet protector 34 is integrally attached to the terminal body 31, it is difficult to exchange the sheet protector 34 at a time of getting damaged or removed.

When the sheet protector 34 is supported by the terminal body 31 and the display 32 is hidden while not in use, the sheet protector 34 always hides the surface of the display 32, thereby reducing scratching or getting damaged. When cotton fabric, fiber material, a synthetic resin film or the like is used as material of the sheet protector 34, the sheet protector can be folded or unfolded with small force. In addition, without having an impact on the entire thickness or weight of the terminal, the display 32 can be protected. If the sheet protector increases in thickness, the impact resistance of the display 32 will be reinforced.

FIGS. 8(a) and 8(b) shows the data transmitting/receiving terminal comprising the terminal body 31, the display 32 and the touch screen 33, which are integrally formed, and having the sheet protector 34 installed on the top surface of the touch screen 33. The protecting function, action or the like of the sheet protector 34 on the display 32 is analogous to that of the embodiment in FIGS. 7(a) and 7(b).

It can be seen that while the structure as shown in FIG. 7(a) and FIG. 7(b) are more effective to prevent the surface of the display from scratching, the structure as shown in FIG. 8(a) and FIG. 8(b) is more effective to prevent the loss of input function, such as the non-uniformity of the transparent conductive film or the linearity deformation of the electrode, by installing the sheet protector 34 on the top surface of the touch screen 33 instead of the display 32.

When the sheet protector 34 is installed on the terminal body 31, it is difficult to make a sufficient preparation against the impact. However, by developing appropriate material, this can be complemented to a certain extent. Meanwhile, the main purpose of the sheet protector is to make a preparation against damage such as scratching. Considering the characteristics of the wireless data transmitting/receiving terminal, the design of lightness and thinness is needed most. Thus, as in the prior art, only with the simple covering of the terminal body with a cover, it is difficult to realize the optimal design and accordingly the commercial value of the sheet protector cannot be maintained. Therefore, the sheet protector 34 capable of achieving lightness and thinness can be applied to effectively protect the wireless data transmitting/receiving terminal with its characteristics maximized. When the sheet protector has got damaged, by attaching and detaching the support bands as described above, it can be exchanged with another sheet protector, and further its compatibility in accordance with user's taste or preference can be maintained.

Therefore, according to the present invention, the sheet protector for the display and the touch screen particularly suitable for the usage purpose of the wireless data transmitting/receiving terminal can be provided. The present invention can be applied to the data transmitting/receiving terminal with its thinness, lightness and miniaturization characteristics maintained. Structurally, since the sheet protector can be installed and detached, and the compatibility of exchange and substitution for another sheet protector can be kept, there is an advantage in that the customization of products and the user's taste can be satisfied. When the wireless data transmitting/receiving terminal is integrally provided with the touch screen, there is also an advantage in that the touch screen can be prevented from getting damaged by means of the sheet protector and the loss problem of its input function can be prevented.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A data transmitting/receiving terminal with a terminal body and a display integrally formed therein, said terminal body having said display mounted thereon and input buttons arranged at regions excluding a display area and substituting for a portion of input function of a mouse, a keyboard or the like, comprising:
a sheet protector is installed on said display of said terminal body;
said terminal body includes a support band capable of at least one of: supporting and arbitrarily attaching, said sheet protector as a complementary structure to one end at regions at least excluding said display area; and
said sheet protector includes a support band adjacent, to said support band of said terminal body and extends from said support band so as to cover and hide said display area.

2. The data transmitting/receiving terminal as claimed in claim 1, wherein said support bands included in said terminal body and said sheet protector are one-touch type fasteners engageable by a pair of male and female portions.

3. The data transmitting/receiving terminal as claimed in claim 1, wherein said support bands included in said terminal body and said sheet protector are detachable tapes.

4. The data transmitting/receiving terminal as claimed in claim 1, wherein said sheet protector is made as a flexible sheet protector.

5. The data transmitting/receiving terminal as claimed in claim 1, wherein said sheet protector is integrally fixed to said terminal body so as to be folded and unfolded along a surface of said display on said terminal body.

6. A data transmitting/receiving terminal comprising a data transmitting/receiving terminal body, a display lying on a portion of said terminal body, and a touch screen added onto said display, which are integrally formed sequentially from below, comprisiong:
a sheet protector is installed on the top surface of said touch screen lying on the top surface of said display integrally formed with said terminal body;
said terminal body includes a support band capable of at least one of: supporting and arbitrarily attaching, said sheet protector as a complementary structure to one end at regions at least excluding an active area of said display and touch screen; and
said sheet protector includes a support band adjacent to said support band of said terminal body so as to hide said active area of said display and touch screen of said terminal body.

7. The data transmitting/receiving terminal as claimed in claim 6, wherein said support bands included in said terminal body and said sheet protector are one-touch type fasteners engageable by a pair of male and female portions.

8. The data transmitting/receiving terminal as claimed in claim 6, wherein said support bands included in said terminal body and said sheet protector are detachable tapes.

9. The data transmitting/receiving terminal as claimed in claim 6, wherein said sheet protector is made as a flexible sheet protector.

10. The data transmitting/receiving terminal as claimed in claim 6, wherein said sheet protector is integrally fixed to said terminal body so as to be folded and unfolded along a surface of said display.
